(19) United States
(12) Patent Application Publication
(10) Pub. No.: US 2022/0314659 A1
(43) Pub. Date: Oct. 6, 2022

(54) DETERMINE RELATIVE POSITIONS BETWEEN PARTS BY USING LIGHT SENSORS

(71) Applicant: Hewlett-Packard Development Company, L.P., Spring, TX (US)

(72) Inventors: Francisco LOPEZ MORAL, Sant Cugat del Valles (ES); Xavier OLIVA VENTAYOL, Sant Cugat del Valles (ES); Vito DI VIRGILIO, Sant Cugat del Valles (ES)

(73) Assignee: Hewlett-Packard Development Company, L.P., Spring, TX (US)

(21) Appl. No.: 17/638,650

(22) PCT Filed: Sep. 5, 2019
(86) PCT No.: PCT/US2019/049763

§ 371 Date: Feb. 25, 2022

(51) Int. Cl. B41J 11/00; G01C 3/08; B41J 3/36

(52) U.S. Cl. CPC B41J 11/00222; G01C 3/08; B41J 3/36

(57) ABSTRACT

A system to determine a relative position between a moveable part and a working surface is disclosed. The system comprises a controller to control a light emitter from an array of light emitters to emit a signal at a setting, the setting being indicative of a position associated with the light emitter. The controller further to receive a signal from the sensor indicative of the setting. The controller also to determine the relative position between a moveable part and the working surface based on the signal.

### BACKGROUND

Inkjet printers are systems that generate printed images by propelling printing fluid through nozzles onto printing media locations associated with virtual pixels. The printing fluid drops may comprise pigments or dyes disposed in a liquid vehicle.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1 is a schematic diagram showing an example of a system to determine the relative position between a fixed part and a moveable part.

FIG. 2 is a flowchart of an example method for determining a relative position a fixed part and a moveable part.

FIG. 3 is a schematic diagram showing an example of another system to determine the relative position between a fixed part and a moveable part.

FIG. 4 is a flowchart of an example method for instructing a printhead to print a part of an image.

FIG. 5 is a schematic diagram showing an example of another system to determine the relative position between a fixed part and a moveable part.

### DETAILED DESCRIPTION

The following description is directed to various examples related to printing systems, apparatuses and processes to generate high quality printed objects. Throughout the present disclosure, the terms “a” and “an” are intended to denote at least one of a particular element. In addition, as used herein, the term “includes” means includes but not limited to, the term “including” means including but not limited to. The term “based on” means based at least in part on.

For simplicity, it is to be understood that in the present disclosure, elements with the same reference numerals in different figures may be structurally the same and/or may perform the same functionality.

Some examples of printers may include a handle or any other suitable element that enables the printer to be handled by a user and thereby to be moveable throughout the workspace. Some of these printers may be commonly referred to as handheld or user-propelled printers.

Some handheld printers may print images on a wide variety of printed media that may have different characteristics. Some examples of these characteristics may include texture, porosity, glossiness, and the like. Some printing systems may print in a textile media or fabric by, for example, propelling a printing fluid directly on the textile. Other printing systems may print images in a transfer media, these images are then transferred from the transfer media to the textile media or fabric. Additionally, some of these printing systems examples may place the printed textile media over a post-processing machine (e.g., sublimating machine) to remove the liquid carrier of the printing fluid and to penetrate the pigments or dyes disposed in the liquid vehicle in through the fibers of the fabric.

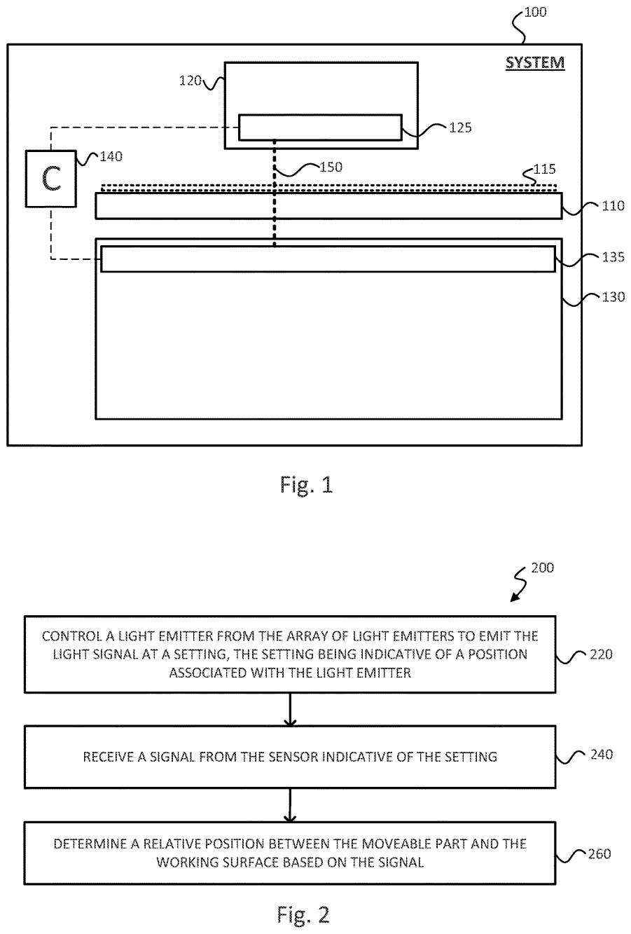

Referring now to the drawings, FIG. 1 is a schematic diagram showing an example of a system 100 to determine the relative position between a fixed part 130 and a moveable part 120, The moveable part 120 may be moveable with respect to the fixed part 130. In an example, a user may move the moveable part 120 with respect to the fixed part 130, In another example, a moving mechanism may move the moveable part 120 with respect to the fixed part 130. A moving mechanism may be a robotic arm, a driving mechanism, or any suitable mechanism that enables the relative movement of the moveable part 120 with respect to the fixed part 130.

The system 100 further comprises a working surface 110. The working surface 110 may be a surface to place a media 115 thereon. The media 115 is illustrated in dotted lines to indicate that although the media 115 is not part of the system 100, the media 115 interacts with the system 100 in use. The media 115 may be any media capable to be printed thereon. Some examples of media 115 may include textile, paper, wood, and/or metal. The working surface 110 is located between the moveable part 120 and the fixed part 130. In some examples, the fixed part 130 comprises the working surface 110 as an integral part thereon.

The moveable part 120 further comprises an element 125 and the fixed part 130 comprises a complimentary element 135. The element 125 is either an array of light emitters or an array of light sensors. The complimentary element 135 is the other of the array of light emitters or the array of light sensors. In an example herein, the element 125 from the moveable part 120 is an array of light emitters and the complimentary element 135 from the fixed part 130 is an array of light sensors. In another example herein, the element 125 from the moveable part 120 is an array of light sensors and the complimentary element 135 from the fixed part 130 is an array of light emitters.

Each of the light emitters from the array of light emitters is to send a light signal 150. Each of the light emitters may send the respective light signal 150 at a setting. The setting may be indicative of the position of the light emitter that sent the light signal 150, with respect to the array of light emitters. A sensor from the array of light sensors is to receive the light signal 150. In some examples, a media 115 may be placed between the emitter and the sensor. In these examples, the light signal 150 sent by the emitter, may traverse the media 115 to be received by the corresponding sensor. Thereby, the media 115 may be any media suitable to be traversed by the light signal 150.

The setting of the light signal 150 sent by a light emitter may be implemented in a number of different ways. In an example, the light signal 150 is a pulse parameter in which the frequency of the pulse being indicative of the position of the light emitter that sent the light signal 150 with respect to the array of light emitters. In another example, the light signal 150 is a color parameter in which the color is indicative of the position of the light emitter that sent the light signal 150 with respect to the array of light emitters (e.g., color map). In another example, the light signal 150 is an intensity parameter in which the intensity of the light being indicative of the position of the light emitter that sent the light signal 150 with respect to the array of light emitters (e.g., intensity map). In yet another example, the light signal 150 is a wavelength parameter in which the wavelength of the light signal 150 being indicative of the position of the light emitter that sent the light signal 150 with respect to the array of light emitters.

A light emitter may be any device suitable for emitting the light signal 150 disclosed herein. For example, the array of light emitters may be an array of Light-Emitting Diodes (LED). In an example, a LED from the array of LEDs is to emit a coded light pulse associated with the LED, to pass through the media on the working surface to be further received by a sensor located on an opposite side of the media as the array of LEDs. In another example, a LED from the array of LEDs is to emit a light signal 150 at a color associated with the LED, to pass through the media to be further received by a sensor. In another example, a LED from the array of LEDs is to emit a light signal 150 at an intensity associated with the LED, to pass through the media to be further received by a sensor. In yet another example, a LED from the array of LEDs is to emit a light signal 150 at a wavelength associated with the LED, to pass through the media to be further received by a sensor.

The system 100 additionally comprises a controller 140 coupled to element 125 and complimentary element 135. The controller 140 may be any combinations of hardware and programming that may be implemented in a number of different ways. For example, the programming of modules may be processor-executable instructions stored on at least one non-transitory machine-readable storage medium and the hardware for modules may include at least one processor to execute those instructions. In some examples described herein, multiple modules may be collectively implemented by a combination of hardware and programming. In other examples, the functionalities of the controller 140 may be, at least partially, implemented in the form of an electronic circuitry. The controller 140 may be a distributed controller, a plurality of controllers, and the like.

The controller 140 may execute a method such as the method 200 of FIG. 2 for determining a relative position a fixed part 130 and a moveable part 120. Additionally, or alternatively, the controller 140 may be to execute other methods such as the further method 400 of FIG. 4.

FIG. 2 is a flowchart of an example method 200 for determining a relative position a fixed part 130 and a moveable part 120.

At block 220, the controller (e.g., controller 140) may control a light emitter from the array of light emitters to emit the light signal 150 at a setting. In some examples, the controller may control a plurality of light emitters from the array of light emitter, each light emitter to emit a light signal with a corresponding setting. As disclosed above, the setting is indicative of the position of the light emitter with respect to the array of light emitters, thereby a plurality of light emitters emit a plurality of light signals, each light signal may be emitted at a different setting based on the position of the emitter. Each light signal 150 is to be received by a sensor. In an example, each light signal may be received by a different sensor. In another example, more than one light signal from the plurality of light signals may be received by the same sensor. The sensor may send the received light signal or data associated with the received light signal to the controller.

At block 240, the controller may receive a signal from the sensor indicative of the setting. In some examples, the controller may also receive data from the sensor indicative of the position of the sensor relative to the array of light sensors. In an example, the setting is a coded pulse parameter indicative of the position of the light emitter with respect to the array of light emitters. In other examples, the setting may be a color parameter, an intensity parameter, a wavelength, or any other suitable parameter that indicates the position of the light emitter that sent the light signal 115 with respect to the array of light emitters. In some examples, the controller has been encoded with a pulse parameter code, a color map, an intensity map, or a wavelength map to map the position of the emitter with respect to the array of light emitters based on the received signal.

At block 260, the controller may determine the relative position between the moveable part 120 and the working surface 110 based on the signal. The controller may determine the relative position between the moveable part 120 and the working surface 110 based on, for example, the position of the emitter previously determined based on the setting, and the position of the sensor that received the light signal 150. In some examples, the position of the sensor is directly indicative of a position from the working surface 110. In other examples, the position of the sensor is used by the controller to map the corresponding position of the working surface 110. In some examples, a plurality of light signals 150 sent by different light emitters may be used to determine the position of the movable device 120 with respect to the working surface 110, for example three light signals 150.

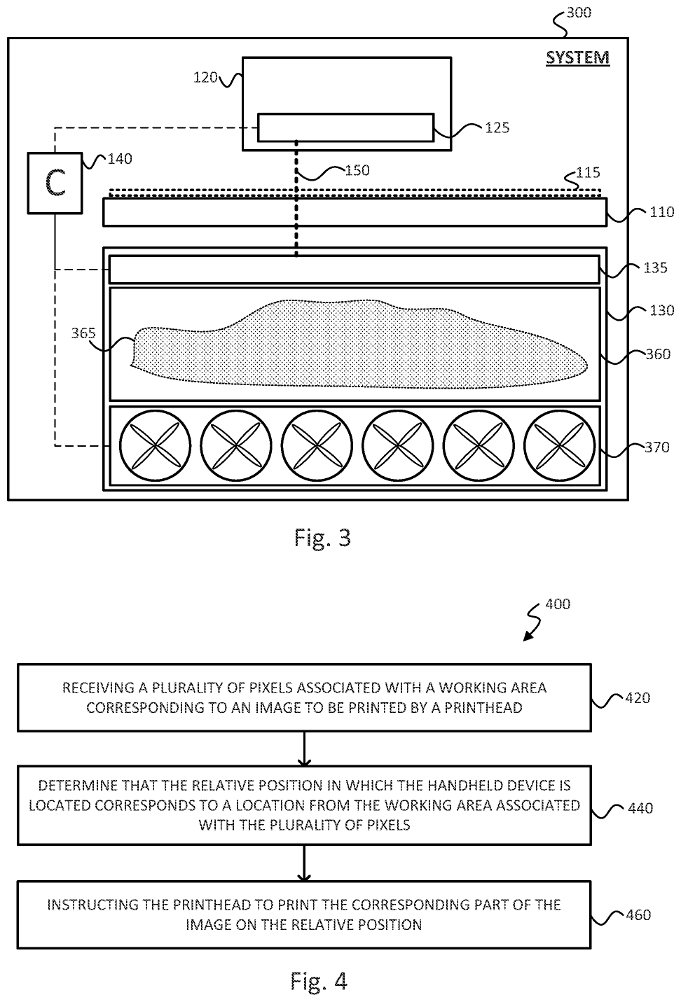

FIG. 3 is a schematic diagram showing an example of another system 300 to determine the relative position between a fixed part 130 and a moveable part 120. Parts of the system 300 may be the same as or similar to parts of the system 100 from FIG. 1. System 300 comprise the moveable part 120 with the element 125, the fixed part 130 with the complimentary element 135, and the controller 140. The controller 140 is to perform the method 200 from FIG. 2. Additionally, the controller 140 may also perform method 400 from FIG. 4.

In an example, the fixed part 130 is a drying and/or curing station. Therefore, the fixed part 130 may further comprise a heater 360 suitable for heating a gas fluid 365 located therein. The gas fluid 365 may be air. In an example, the heater 360 includes a ceramic element or a plurality of ceramic elements connected to a power source (not shown). The ceramic element(s) may heat up upon receiving a voltage from a power source and, by extension, the ceramic elements) may heat the gas fluid 365 flowing therein. In other examples, the heater 360 may be any other suitable heating device for heating a gas fluid 365. The heater 360 may be located between the working surface 110 and a plurality of blowing devices 370.

The fixed part 130 further comprises the plurality of blowing devices 370, located below the heater 360, to blow the heated gas fluid 365 through the heater 360 towards the media 115. In the examples herein, a blowing device may be any device suitable to move an amount of a gas fluid, for example, a fan. The plurality of blowing devices 370 may blow the heated gas fluid 365 towards the media to, for example, perform a post-processing operation to the media 115. In an example, the post-processing operation may include at least one of heating, drying, sublimating, and/or thermal curing.

When in use, each blowing device from the plurality of blowing devices 370 may blow the heated gas fluid to a specific area of the working surface and, by extension, to a specific area of the media 115. Furthermore, each blowing device may be individually controllable by the controller 140. Therefore, the controller 140 may control which areas from the media 115 are to be post-processed by controlling a subset of blowing devices from the plurality of blowing devices 370.

The controller 140 is to execute the method 200 of FIG. 2 for determining a relative position a fixed part 130 and a moveable part 120. Additionally, or alternatively, the controller 140 may be to execute method 400 from FIG. 4.

FIG. 4 is a flowchart of an example method 400 for instructing a printhead to print.

At block 420, the controller (e.g., the controller 140 of FIG. 1) may receive data comprising the location of a plurality of pixels associated with the working area 110 corresponding to an image to be printed by, for example, a printhead on the moveable part 120. In the examples herein, a pixel should be interpreted as a virtual representation of a physical location from, for example, the working surface 110 or the media 115. In an example, the data may be sent from an external server. In another example, the data may be transferred from an internal or external memory that may be located at any location from the system 100 or system 300. In additional examples, the data may be previously encoded in the controller.

The controller may determine the relative position of the moveable part 120 with respect to the fixed part 130 by, for example, executing method 200 from FIG. 2. At block 440, the controller 140 may determine that the relative position in which the moveable part 120 is located, corresponds to a location from the working area 110 associated with the plurality of pixels from the received data. Additionally, at block 460, the controller 140 may instruct the printhead to print the corresponding part of the image in the relative position. In an example, the position of the movable part 120 may also comprise its inclination.

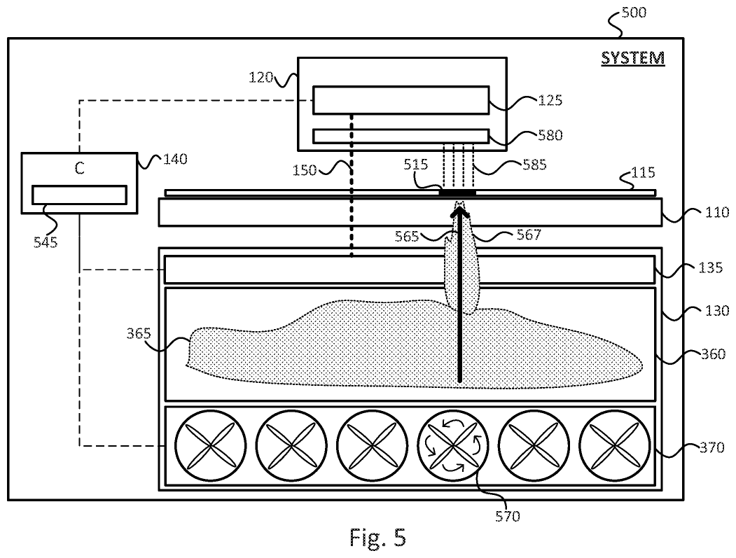

FIG. 5 is a schematic diagram showing an example of another system 500 to determine the relative position between a fixed part 130 and a moveable part 120. Parts of the system 500 may be the same as or similar to parts of the system 100 and/or system 300. The system 500 comprises the moveable part 120 with the element 125, the fixed part 130 with the complimentary element 135 and the controller 140. The controller 140 is to perform the method 200 from FIG. 2. Additionally, the controller 140 may also perform method 400 from FIG. 4.

In the illustrated example of FIG. 5, the moveable part 120 is a handheld printer comprising at least a printhead 580 to eject a printing fluid 585. In some examples, the handheld printer comprises a single printhead 580. In other examples, the handheld printer comprises a plurality of printheads 580. Each printhead 580 may comprise an array of nozzles that may eject a corresponding printing fluid 585. In some examples, the printhead 580 may be a thermal inkjet printhead. In other examples, the printhead 580 may be piezoelectric inkjet printhead. Some examples of printheads have been disclosed, however any other printhead suitable for selectively ejecting an amount of a printing fluid 585 may be used without departing from the scope of the present disclosure.

The printing fluid may also be referred herein as printing composition or as a water-based ink. In an example, the printing fluid may comprise a colorant and/or dye with a liquid carrier; e.g., in cartridges and/or liquid toners (not shown). Some printing fluids may be dye based printing fluids, where dyes may be understood as a coloring solution. Other printing fluids may be pigment based printing fluids, where pigments may be understood as coloring particles in suspension. In another example, the printing fluid may comprise ink particles and an imaging oil liquid carrier. A plurality of examples of the printing fluid that may be propelled by a nozzle have been disclosed, however any other chemical printing fluid comprising an agent in a liquid solvent or in a liquid carrier that may evaporate in contact with ambient air may be used without departing from the scope of the present disclosure.

The controller 140 also comprises a memory 545 to store data. In some examples, the memory 545 comprises data corresponding to the image to be printed on the media 115. As mentioned above, the controller 140 may execute method 200 from FIG. 2 to determine the position of the handheld device (e.g., moveable device 120) with respect to the fixed device 130, Additionally, the controller 140 may instruct the printhead 580 to eject an amount of the printing fluid 585 to a location of the media 115 corresponding to a part the printed image 515. The controller 140 may execute method 400 from FIG. 4 to instruct the printhead 580 to perform such operation.

In some examples herein, the fixed part 130 is a post-processing device to perform at least one post-processing operation to the media 115. In an example, the post-processing operation may include at least one of heating, drying, sublimating, and/or thermal curing. The post-processing device 130 comprises the heater 360 suitable for heating a gas fluid 365 located therein. The post-processing device 130 additionally comprises a plurality of blowing devices 370 located below the heater 360 to blow part of the heated gas fluid 567 towards a location from the media 115 as indicated by the arrow 565. As the heated gas fluid 567 reaches the part of the printed image 515, the post-processing operation occurs.

In an example of the present disclosure, the controller 140 may store in the memory 545 a set of scanning positions corresponding to the determined plurality of relative positions during a print job. In the examples herein, a set of scanning positions may include either all the scanning positions corresponding to the relative positions during a print job, or a part (i.e., a subset) of scanning positions corresponding to the relative positions during a print job. The term print job should be interpreted as the operation of printing a single image, a part of a single image, or a group of images on the media 110.

In the example, the controller 140 may additionally control the plurality of blowing devices 370 to blow the gas fluid 365 based on the set of scanning positions previously stored in the memory 545. In an example, the controller 140 may control a subset of blowing devices 570 from the plurality of blowing devices to blow the gas fluid 365 so that the heated gas fluid 567 reaches the relative locations corresponding to the set of scanning positions stored in the memory 545. In another example, the controller 140 may control a subset of blowing devices 570 from the plurality of blowing devices to blow the gas fluid 365 so that the heated gas fluid 567 reaches a part (or any) of the relative locations corresponding to the set of scanning positions stored in the memory 545.

In another example of the present disclosure, the controller 140 may additionally store in the memory 545 a set of printing positions (e.g., print job positions) from the set of scanning positions corresponding to the plurality of relative positions of the media 115 (or corresponding parts of the working surface 110) in which the printhead 580 has ejected an amount of printing fluid 585 thereon (e.g., printed image 515).

in the example, the controller 140 may additionally control the plurality of blowing devices 370 to blow the gas fluid 365 based on the set of printing positions previously stored in the memory 545. In an example, the controller 140 may control a subset of blowing devices 570 from the plurality of blowing devices to blow the gas fluid 365 so that the heated gas fluid 567 reaches the relative locations corresponding to the set of printing positions stored in the memory 545 (e.g., printed image 515). In another example, the controller 140 may control a subset of blowing devices 570 from the plurality of blowing devices to blow the gas fluid 365 so that the heated gas fluid 567 reaches a part (or any) of the relative locations corresponding to the set of printing positions stored in the memory 545.

In yet another example of the present disclosure, the complimentary element 135 from the fixed device 130 is an array of light emitters and the element 125 from the moveable device 120 is an array of sensors. The controller 140 may receive a plurality of pixels associated with a plurality of locations in the working area 110 corresponding to an image to be printed by the printhead 580. In the example, the controller 140 may instruct the array of light emitters (e.g., complimentary element 135) from the fixed part 130 corresponding to the plurality of locations in the working area 110 associated with the plurality of pixels, to emit light and thereby visually indicate the plurality of locations to be printed to a user.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processors, or a combination thereof.

As used herein, the terms “about” and “substantially” are used to provide flexibility to a numerical range endpoint by providing that a given value may be, for example, an additional 20% more or an additional 20% less than the endpoints of the range. The degree of flexibility of this term can be dictated by the particular variable and would be within the knowledge of those skilled in the art to determine based on experience and the associated description herein.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1: A system comprising:
a working surface to place a media thereon, the working surface located between a movable part and a fixed part;
the movable part comprising one of an array of light emitters or an array of light sensors;
the fixed part comprising the other one of the array of light emitters or the array of sensors;
being the light sensors to receive a light signal from the array of light emitters; and
a controller to:
   control a light emitter from the array of light emitters to emit the light signal at a setting, the setting being indicative of a position associated with the light emitter,
   receive a signal from the sensor indicative of the setting, and
   determine a relative position between the moveable part and the working surface based on the signal.

Feature set 2: A system with feature set 1, wherein the media is a textile,

Feature set 3: A system with any preceding feature set 1 or 2, wherein the setting comprises one of a pulse parameter, a color parameter, an intensity parameter, and a wavelength.

Feature set 4: A system with any preceding feature set 1 to 3, wherein the moveable part is a handheld printer comprising at least a printhead to eject a printing fluid.

Feature set 5: A system with any preceding feature set 1 to 4, wherein the fixed part further comprises: a heater to heat a gas fluid located therein, the heater located between the working surface and a plurality of blowing devices; and a plurality of blowing devices located below the heater to blow a gas fluid through the heater towards the media.

Feature set 6: A system with any preceding feature set 1 to 5, wherein the controller is further to: receive a plurality of pixels associated with the working area corresponding to an image to be printed by the printhead; determine that the relative position in which the handheld device is located corresponds to a location from the working area associated with the plurality of pixels; and instructing the printhead to print the corresponding part of the image on the relative position.

Feature set 7: A system with any preceding feature set 1 to 6, wherein the controller includes a memory to store a set of scanning positions corresponding to a plurality of relative positions determined by the controller during a print job and wherein the controller is to selectively control the plurality of blowing devices to blow the gas fluid based on the set of scanning positions.

Feature set 8: A system with any preceding feature set 1 to 7, wherein the memory is to store a set of printing positions, from the set of scanning positions, corresponding to a plurality of relative positions determined by the controller in which the printhead has ejected an amount of the printing fluid thereon; and wherein the controller is further to selectively control the plurality of blowing devices to blow the gas fluid based on the set of printing positions.

Feature set 9: A system with any preceding feature set 1 to 8, wherein the array of light emitters comprises an array of Light-Emitting Diodes (LED), each LED to emit a coded light pulse to pass through the media on the working surface.

Feature set 10: A system with any preceding feature set 1 to 9, wherein the fixed part comprises the array of light emitters, the moveable part comprises the array of sensor, and the controller is further to: receive a plurality of pixels associated with the working area corresponding to an image to be printed by the printhead; and control the array light sources related to the plurality of locations to emit light as to visually indicate the plurality of locations to a user.

Feature set 11: A handheld device comprising:
a printhead to eject a printing fluid towards a media on a working surface;
an array of light sensors, each light sensor having an assigned position within the handheld device; and
a controller to:
   receive from a light sensor of the array of light sensors a light setting from a light source, the light setting being indicative of a working surface position, and
   determine a relative position between the handheld device and the working surface based on the signal.

Feature set 12: A post-processing device comprising:
a working surface to place a media thereon;
an array of light emitters to emit light at a setting indicative of the position the light emitter with respect to the working surface;
being a light sensor from a moveable device to receive the light signal from the array of light emitters; and
a controller to:
   receive a signal from the light sensor indicative of the setting, wherein the sensor is located at a position within the movable device, and
   determine a relative position between the movable device and the working surface based on the signal.

Feature set 13: A post-processing device with the preceding feature set 12, further comprising: a heating chamber with a gas fluid therein; a heating element within the heating chamber to heat the gas fluid; and a plurality of blowing devices located below the heater to blow a gas fluid through the heater chamber towards the media.

Feature set 14: A post-processing device with any preceding feature set 12 to 13, wherein a printhead from the movable device is to eject a printing fluid on a set of printing positions of the media, the controller is further to: include a memory to store the set of printing positions; and selectively control the plurality of blowing devices to blow the gas fluid based on the set of printing positions.

Feature set 15: A post-processing device with any preceding feature set 12 to 14, wherein the setting is at least one of a pulse parameter, a color parameter, an intensity parameter, and a wavelength.

What it is claimed is:

1. A system comprising:
a working surface to place a media thereon, the working surface located between a movable part and a fixed part;
the movable part comprising one of an array of light emitters or an array of light sensors;
the fixed part comprising the other one of the array of light emitters or the array of sensors;
being the light sensors to receive a light al from the array of light emitters; and
a controller to:
control a light emitter from the array of light emitters to emit the light signal at a setting, the setting being indicative of a position associated with the light emitter,
receive a signal from the sensor indicative of the setting, and
determine a relative position between the moveable part and the working surface based on the signal.

2. The system of claim 1, wherein the media is a textile.

3. The system of claim 1, wherein the setting comprises one of a pulse parameter, a color parameter, an intensity parameter, and a wavelength.

4. The system of claim 1, wherein the moveable part is a handheld printer comprising at least a printhead to eject a printing fluid.

5. The system of claim 4, wherein the fixed part further comprises:
a heater to heat a gas fluid located therein, the heater located between the working surface and a plurality of blowing devices; and
a plurality of blowing devices located below the heater to blow a gas fluid through the heater towards the media.

6. The system of claim 4, wherein the controller is further to:
receive a plurality of pixels associated with the working area corresponding to an image to be printed by the printhead;
determine that the relative position in which the handheld device is located corresponds to a location from the working area associated with the plurality of pixels; and
instructing the printhead to print the corresponding part of the image on the relative position.

7. The system of claim 5, wherein the controller includes a memory to store a set of scanning positions corresponding to a plurality of relative positions determined by the controller during a print job; and wherein the controller is to:
selectively control the plurality of blowing devices to blow the gas fluid based on the set of scanning positions.

8. The system of claim 7, wherein the memory is to store a set of printing positions, from the set of scanning positions, corresponding to a plurality of relative positions determined by the controller in which the printhead has ejected an amount of the printing fluid thereon; and wherein the controller is further to:
selectively control the plurality of blowing devices to blow the gas fluid based on the set of printing positions.

9. The system of claim 1, wherein the array of light emitters comprises an array of Light-Emitting Diodes (LED), each LED to emit a coded light pulse to pass through the media on the working surface.

10. The system of claim 1, wherein the fixed part comprises the array of light emitters, the moveable part comprises the array of sensor, and the controller is further to:
receive a plurality of pixels associated with the working area corresponding to an image to be printed by the printhead; and
control the array light sources related to the plurality of locations to emit light as to visually indicate the plurality of locations to a user.

11. A handheld device comprising:
a printhead to eject a printing fluid towards a media on a working surface;
an array of light sensors, each light sensor having an assigned position within the handheld device; and
a controller to:
receive from a light sensor of the array of light sensors a light setting from a light source, the light setting being indicative of a working surface position, and
determine a relative position between the handheld device and the working surface based on the signal.

12. A post-processing device comprising:
a working surface to place a media thereon;
an array of light emitters to emit light at a setting indicative of the position of the light emitter with respect to the working surface;
being a light sensor from a moveable device to receive the light signal from the array of light emitters; and
a controller to:
receive a signal from the light sensor indicative of the setting, wherein the sensor is located at a position within the movable device, and
determine a relative position between the movable device and the working surface based on the signal.

13. The post-processing of claim 12, further comprising:
a heating chamber with a gas fluid therein;
a heating element within the heating chamber to heat the gas fluid; and
a plurality of blowing devices located below the heater to blow a gas fluid through the heater chamber towards the media.

14. The post-processing device of claim 13, wherein a printhead from the movable device is to eject a printing fluid on a set of printing positions of the media, the controller is further to:
include a memory to store the set of printing positions; and
selectively control the plurality of blowing devices to blow the gas fluid based on the set of printing positions.

15. The post-processing device of claim 12, wherein the setting is at least one of a p parameter, a color parameter, an intensity parameter, and a wavelength.
